(19) United States
(12) Patent Application Publication
(10) Pub. No.: US 2012/0162072 A1
(43) Pub. Date: Jun. 28, 2012

(54) Optical Pointing Device

(75) Inventors: Hui-Hsuan Chen, Hsin-Chu (TW); Tien-Chia Liu, Hsin-Chu (TW); Hung-Ching Lai, Hsin-Chu (TW); Yen-Min Chang, Hsin-Chu (TW)

(73) Assignee: PIXART IMAGING INC., Hsin-Chu (TW)

(21) Appl. No.: 13/411,742

(22) Filed: Mar. 5, 2012

Related U.S. Application Data
(63) Continuation-in-part of application No. 12/108,800, filed on Apr. 24, 2008.

(51) Int. Cl. G09G 5/08

(52) U.S. Cl. 345/157

(57) ABSTRACT

An optical pointing device including a light source, an optical transfer assembly, a light beam splitter, and an image sensor is provided. The light source provides an illumination light beam. The optical transfer assembly concentrates the illumination light beam. The light beam splitter is disposed on a transmission path of the illumination light beam for splitting the illumination light beam into a first light beam and a second light beam. The image sensor is capable of sensing the first and the second light beams. When the optical pointing device is used on a reflective surface, the first light beam is reflected to the lens by the reflective surface and then is received by the image sensor; when the optical pointing device is used on a transparent body above the reflective surface, the second light beam would be received by the image sensor.

### CROSS-REFERENCES TO RELATED APPLICATIONS

This application is a continuation-in-part of U.S. Ser. No. 12/108,800, filed on Apr. 24, 2008, which claims the priority of Taiwan Patent Application No. 097104005.

This application claims the benefit of the priority to Taiwan Patent Application No. 097104005 filed on Feb. 1, 2008, the disclosures of which are incorporated herein by reference in their entirety.

### BACKGROUND OF THE INVENTION

1. Field of the Invention

The present invention relates to a pointing device and, particularly, to an optical pointing device.

2. Descriptions of the Related Art

An optical mouse is a commonly used pointing device for controlling a cursor displayed on a computer screen. Generally, the optical mouse is used on a reflective surface. The light beam provided by a light source of the optical mouse is reflected to an image sensor of the optical mouse by the reflective surface. When the optical mouse is moved, the cursor displayed on the screen would correspondingly move on the screen. However, in case of using the optical mouse on a transparent body above a reflective surface, a transmission path of the light beam provided by the optical mouse would be refracted by the transparent body. Therefore, the light beam can not be accurately focused on the image sensor. As a result, the sensitivity of the optical mouse is severely degraded.

FIGS. 1A and 1B respectively illustrate a conventional optical mouse 100 which is able to be used on an opaque body and on a transparent body to overcome the above-mentioned drawbacks. The optical mouse 100 includes a light source 110, a first lens 120, a second lens 130, an image sensor 140 and an optical transfer assembly 150. The light source 110 provides the light beam 112. The optical transfer assembly 150 receives and delivers the light beam 112. The first lens 120 and the second lens 130 are disposed before the image sensor 140 to receive the light beams being reflected by the surface.

Referring to FIG. 1A, when the optical mouse 100 is put on a reflective surface 50 (i.e., opaque body), the light beam 112 generated from the light source 110 is guided towards the reflective surface 50 through the optical transfer assembly 150. The light beam 112 is then reflected to the first lens 120 by the reflective surface 50 and focused on the image sensor 140 via the first lens 120.

Referring to FIG. 1B, when a transparent body 60 (e.g., a glass plate) is disposed on the reflective surface 50 and the optical mouse 100 is used on the transparent body 60, the light beam 112 would firstly pass through the transparent body 60 and then is reflected by the reflective surface 50. Since the refraction phenomenon occurs at both of the light beam 112 entering into the transparent body 60 and exiting from the transparent body 60, the second lens 130 is disposed on the transmission path of the light beam 112 exited from the transparent body 60 to focus the light beam 112 on the image sensor 140.

It is understandable that the entire energy of the light beam is invariable and the sensitivity of an optical mouse would depend on the optical strength or the illumination area of the light beam. When the illumination area of the light beam is smaller, the optical strength would be greater; on the contrary, when the illumination area of the light beam is wider, the optical strength would be weaker. It would be more significant when the optical mouse 100 is working in a poor light-reflecting or scattering environment, for example, on a glass plate. The light strength received by the image sensor 140 would be much weaker and thus erroneous detections may probably occur.

Furthermore, a laser diode may be adopted as the light source 110 in the optical mouse 100, which is named as a laser optical mouse. In the conventional laser optical mouse, the laser beams are always regulated at a certain angle according to a certain environment or working surface. However, the sensitivity of the laser optical mouse would be influenced due to different reflection indexes of the different operational surfaces. For example, when a laser optical mouse designed for a rough surface works on a flat surface, merely very few of the reflected light beams would be detected by the image sensor 140 and thus the sensitivity would be decreased. If plural sets of lens are equipped for different surfaces to solve the problems, it would bring other disadvantages such as increasing the manufacturing cost and the volume of the optical mouse.

As for the image sensor 140, it is generally constituted by a plurality of sensor unites to determine the movement by sensing the speckles from the reflective surface 50. Conventionally, a distance between the geometric centers of any two sensor units of the sensor chip is larger than 30 micrometers. However, the conventional laser optical mouse may be insufficient to accurately determine the movement because a distance between any two speckles formed by the laser diode illuminating surface details on the laser optical mouse is only about 7 micrometers, which is much shorter than 30 micrometers.

### SUMMARY OF THE INVENTION

One objective of the present invention is to provide an optical pointing device having good sensitivity even if the optical pointing device works on a transparent body disposed on a reflective surface.

Another objective of this invention is to provide an optical pointing device having the light beams being concentrated. In the optical pointing device of the present invention, the illumination area of the light beam is optically narrowed so as to enhance the optical strength of the light beams. The optical condense would be effectively increase the sensitivity of the optical pointing device.

Yet a further objective of this invention is to provide an optical pointing device which has the light beams being scattered with different incident angles with respect to the reflective surface. Thus, the optical pointing device would be suitable for use on various working surfaces with different roughness.

An additional objective of this invention is to provide an optical pointing device having a well arranged sensor units of the image sensor for sensing speckles reflected formed on the reflective surface. The distance between the geometric centers of two nearest sensor units is shorter than 30 micrometers.

In order to achieve the above-mentioned objectives, an optical pointing device in accordance with the embodiments of the present invention is provided. The optical pointing device includes a light source, an optical transfer assembly, and an image sensor. The light source is configured (i.e., structured and arranged) to provide the illumination light beam. The optical transfer assembly is utilized to concentrate the illumination light beam. The light beam splitter is disposed on a transmission path of the illumination light beam after the optical transfer assembly and is configured for splitting the illumination light beam into a first light beam and a second light beam. The image sensor is capable of sensing at least one of the first light beam and the second light beam. The first light beam is reflected by the reflective surface to be guided towards the image sensor when the optical pointing device is directly used on the reflective surface, and the second light beam is reflected by the reflective surface to be guided towards the image sensor when the optical pointing device is used on a transparent body above the reflective surface.

In one embodiment of the present invention, the optical transfer assembly comprises an inlet lens, a first directing surface, a second directing surface and a refracting surface sequentially disposed on the transmission path. The inlet lens focuses the illumination light beam and guides the illumination light beam towards the first directing surface. The first directing surface reflects the illumination light beam from the inlet lens towards the second directing surface. The second directing surface reflects the illumination light beam from the first directing surface towards the refracting surface. The refracting surface then directs the illumination light beam towards the light beam splitter. Specifically, at least one of the second reflecting surface and the refracting surface is a curved surface, and the inlet lens is a convex lens.

In one embodiment of the present invention, the light beam splitter is a prism or a grating.

In one embodiment of the present invention, the light beam splitter has the first emitting area for the first light beam travelling therethrough, in which the first emitting area has a plurality of emitting surfaces with different normals for transferring the first light beam into a plurality of light beams with different incident angles on the reflective surface.

In one embodiment of the present invention, the optical pointing device further includes a reflection element disposed on a transmission path of the second light beam and configured for reflecting the second light beam through the transparent body to the reflective surface.

In one embodiment of the present invention, the lens, light beam splitter and reflection element is capable of being integrally formed.

In one embodiment of the present invention, the reflection element can be a prism or a reflective mirror.

In one embodiment of the present invention, the image sensor of the optical pointing device has a plurality of sensor units for sensing speckles formed on the reflective surface and generating image data. Each of the sensor units has a geometric center and the sensor units are arranged to have a distance between the geometric centers of two nearest sensor units shorter than 30 micrometers.

In one embodiment of the present invention, the light source is a light emitting diode (LED) or a laser diode (LD).

In one embodiment of the present invention, the image sensor is a complementary metal oxide semiconductor (CMOS) image sensor or a charge coupled device (CCD).

Due to the fact that the illumination light beam is split into the first light beam and the second light beam by the light beam splitter, when the optical pointing device works on the reflective surface, the first light beam is reflected to the image sensor, and when the optical pointing device works on the transparent body above the reflective surface, the second light beam is reflected to the image sensor. Therefore, the optical pointing device could have good sensitivity even if the optical pointing device is utilized on the transparent body above the reflective surface.

### BRIEF DESCRIPTION OF THE DRAWINGS

FIGS. 1A and 1B respectively illustrate a conventional optical pointing device being used on an opaque body and on a transparent body.

FIGS. 2A and 2B respectively illustrate an optical pointing device, in accordance with an embodiment of the present invention, being used on an opaque body and on a transparent body.

FIGS. 3A, 3B and 3C illustrate the optical transfer assembly with the curved surface to concentrate the light beams in another embodiment.

FIG. 4 illustrates the light beam splitter having the emitting surfaces to scatter the light beams in another embodiment.

FIG. 5 illustrates the image sensor of the optical pointing device.

FIG. 6 illustrates the light beam splitter, the reflection element and the lens being integrally formed in another embodiment.

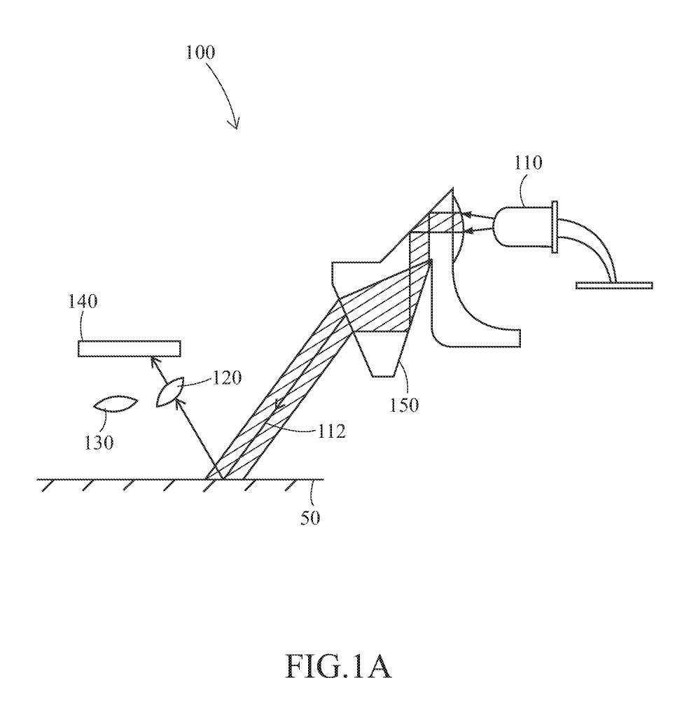

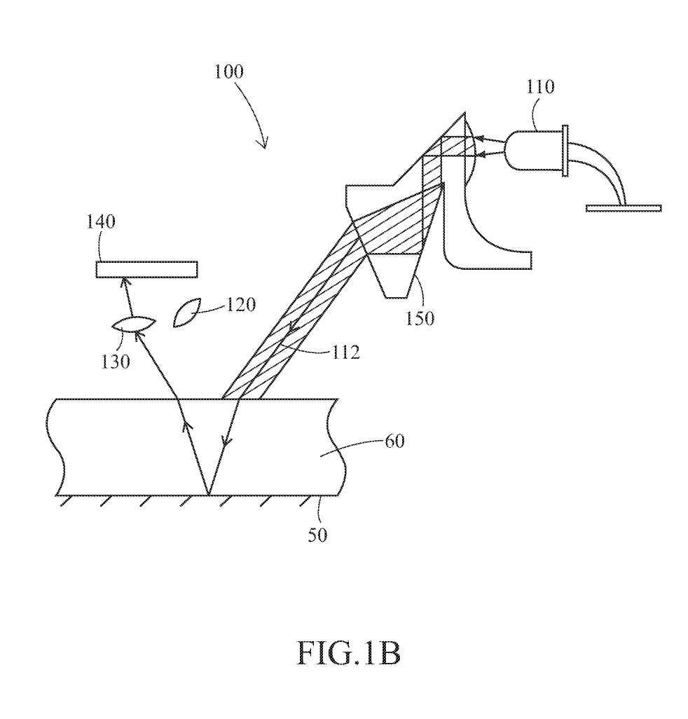

### DESCRIPTION OF THE PREFERRED EMBODIMENT

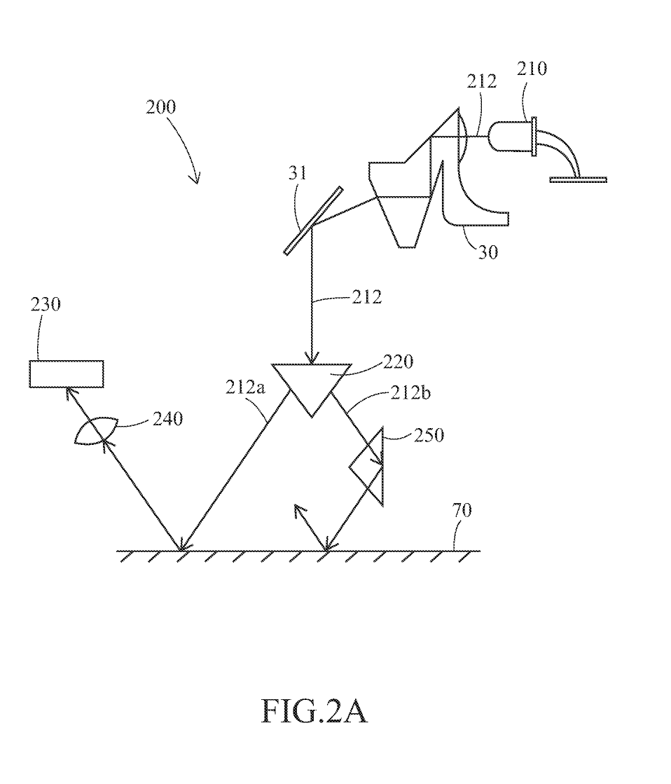

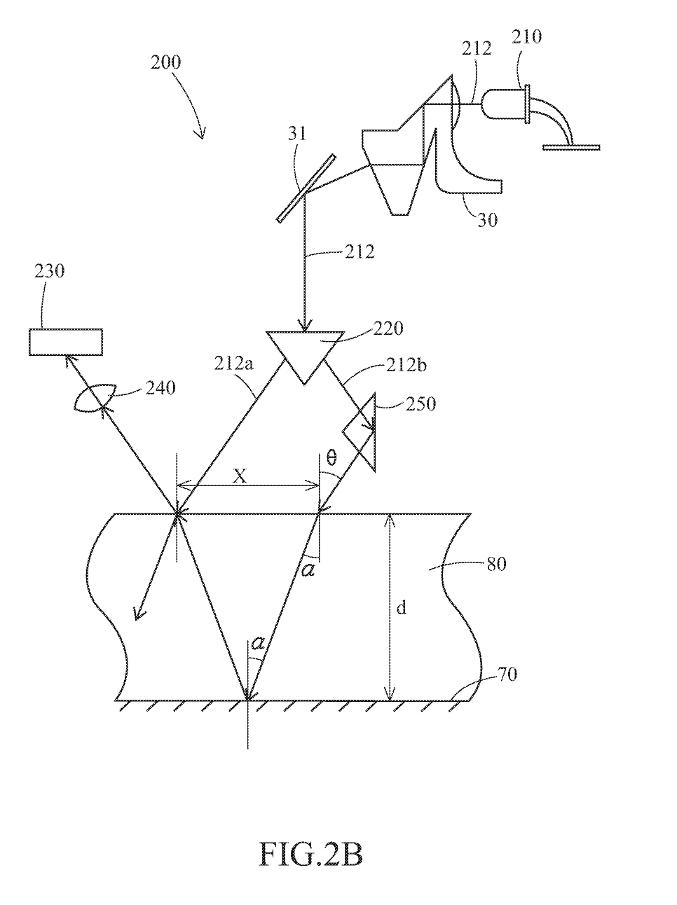

As illustrated in FIGS. 2A and 2B, the optical pointing device 200 is disclosed. The optical pointing device 200 includes a light source 210, a light beam splitter 220, an image sensor 230 and a lens 240. The light source 210 is configured (i.e., structured and arranged) for providing an illumination light beam 212. The light beam splitter 220 is disposed on a transmission path of the illumination light beam 212 to split the illumination light beam 212 into a first light beam 212a and a second light beam 212b. The lens 240 is disposed before the image sensor 230 for focusing the first light beam or the second light beam onto the image sensor 230. The image sensor 230 is configured for sensing at least one of the first light beam 212a and the second light beam 212b.

In the preferred embodiment, the optical pointing device 200 further comprises an optical transfer assembly 30 being disposed on the transmission path of the illumination light beam 212 before the light beam splitter 212. Preferably, the optical pointing device 200 further comprises a reflector 31 disposed on the transmission path after the optical transfer assembly 30 to guide the illumination light beam 212 towards the light beam splitter 220.

The light source 210 of the optical pointing device 200 can be a light emitting diode (LED) or a laser diode (LD). The image sensor 230 can be a complementary metal oxide semiconductor (CMOS) image sensor or a charge coupled device (CCD). Furthermore, the light beam splitter 220 as illustrated in FIGS. 2A and 2B can be a prism, or other light beam splitter such as a grating. In addition, the optical pointing device 200 can further include a reflection element 250, which is disposed on a transmission path of the second light beam 212b and configured for reflecting the second light beam 212b through a transparent body 80 to the reflective surface 70. The reflection element 250 as illustrated in FIGS. 2A and 2B can be a prism, or other reflection element such as a reflective mirror.

In order to allow the optical pointing device 200 to have good sensitivity at both of the circumstances of the optical pointing device 200 being used on a transparent body 80 and on an opaque body, the light beam splitter 220 is disposed after the optical transfer assembly 30 and is used to split the illumination light beam 212 provided by the light source 210 into the first light beam 212a and the second light beam 212b.

As illustrated in FIG. 2A, when the optical pointing device 200 works on the reflective surface 70 of the opaque body, the first light beam 212a and the second light beam 212b are directly reflected by the reflective surface 70. In this case, only the first light beam 212a would be reflected to the lens 240 and then is focused on the image sensor 230 by the lens 240. In other words, when the optical pointing device 200 is directly located on the reflective surface 70 of the opaque body, the first light beam 212a would be reflected by the reflective surface 70 and only the first light beam 212a would be guided towards and sensed by the image sensor 230.

With reference to FIG. 2B, when the transparent body 80 (e.g., glass) is disposed on the reflective surface 70 and the optical pointing device 200 is used on the transparent body 80, the first light beam 212a and second light beam 212b would firstly pass through the transparent body 80 and then be reflected at the reflective surface 70. Thereafter, the first light beam 212a and second light beam 212b would depart from the transparent body 80. Conceivably, the first light beam 212a and second light beam 212b are refracted when entering into the transparent body 80 and departing from the transparent body 80. In this case, only the second light beam 212b would be reflected towards the image sensor 230 and then is focused on the image sensor 230 by the lens 240. In other words, when the optical pointing device 200 works on the transparent body 80 above the reflective surface 70, only the second light beam 212b would be guided towards and sensed by the image sensor 230.

A distance X between incident points of the first and second light beams 212a, 212b on the transparent body 80 and an incident angle θ of the first and second light beams 212a, 212b are related to a thickness d and a refractive index n1 of the transparent body 80. For example, according to Snell's law, when the refractive index of air n2 is 1, a given thickness d of the transparent body 80 is 1 centimeter (cm), a material of the transparent body 80 is silicon dioxide (refractive index n1=1.4568) and the incident angle θ is equal to 30 degree, the following expression is satisfied:

n2×sin θ=n1×sin α

Accordingly, sin α would be 0.343218, and X=2d×tan α=0.73083 cm.

In the present embodiment, the light beam splitter 220 is utilized to split the illumination light beam 212 provided by the light source 210 into the first light beam 212a and the second light beam 212b. When the optical pointing device 200 is used on the reflective surface 70, the image sensor 230 would be able to sense the first light beam 212a ; and when the optical pointing device 200 is used on the transparent body 80 above on the reflective surface 70, the image sensor 230 would be able to sense the second light beam 212b. Therefore, the optical pointing device 200 in the present embodiment would have better sensitivity regardless of being used on the reflective surface 70 or on the transparent body 80 above the reflective surface 70.

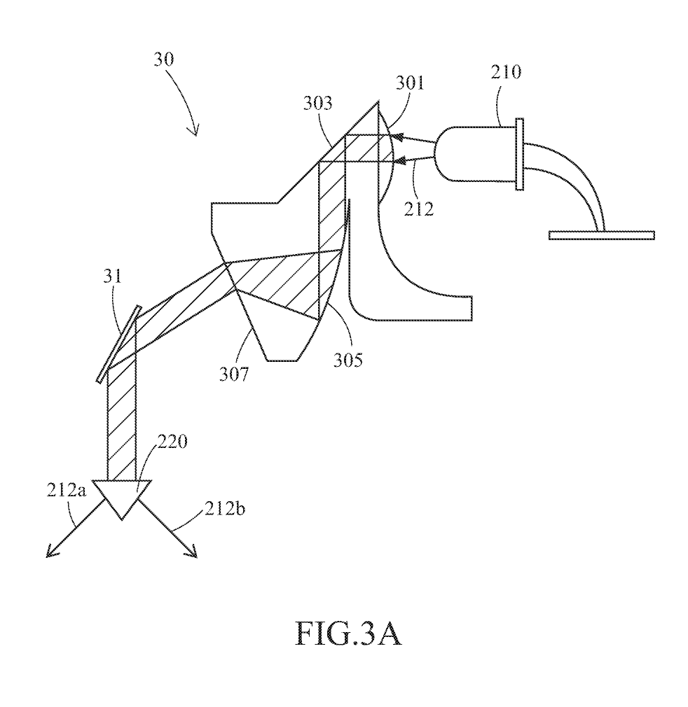

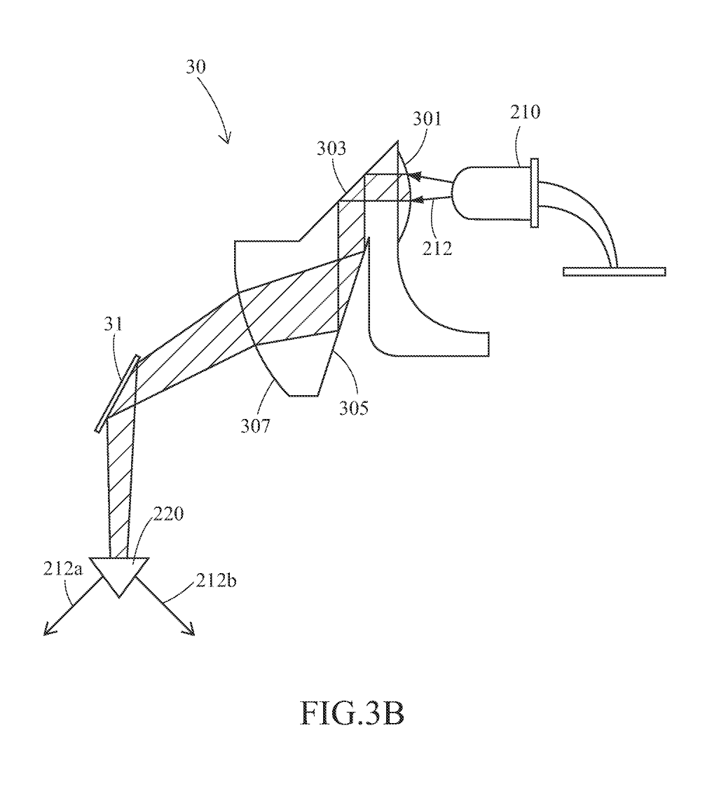

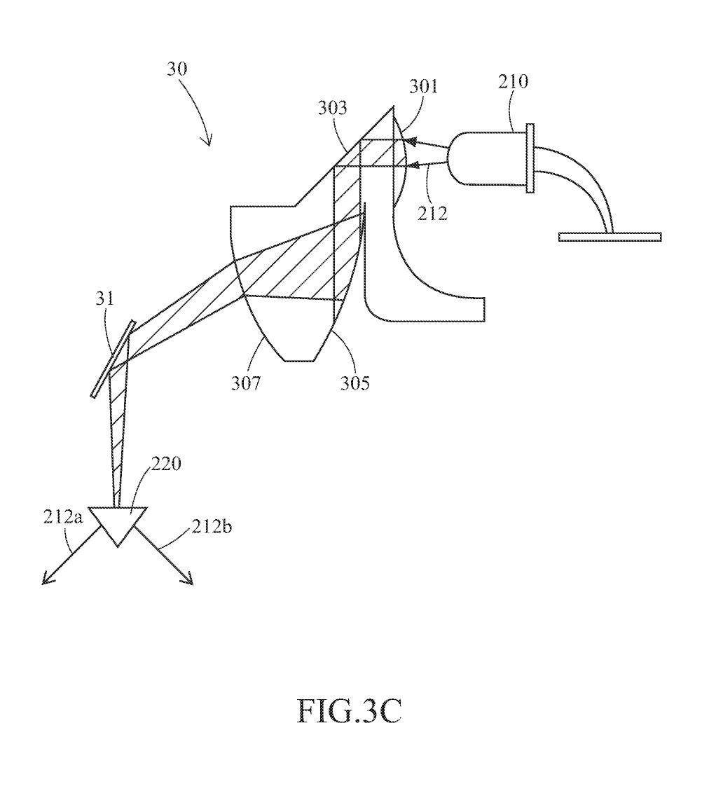

Preferably, in this embodiment, the optical transfer assembly 30 is characterized to concentrate the illumination light beam 212. Specifically, as shown in FIGS. 3A, 3B and 3C, the optical transfer assembly 30 comprises an inlet lens 301, a first directing surface 303, a second directing surface 305 and a refracting surface 307 sequentially disposed on the transmission path. The inlet lens 301 is capable of receiving and focusing the illumination light beam 212. The first directing surface 303 reflects the illumination light beam 212 from the inlet lens 301 towards the second directing surface 305. The second directing surface 305 is then reflecting the illumination light beam 212 which is from the first directing surface 303 towards the refracting surface 307. Finally, the refracting surface 307 directs the illumination light beam 212 towards the light beam splitter 220.

For the objective of enhancing the optical strength of the illumination light beam 212, the inlet lens 301 is a convex lens, and at least one of the second reflecting surface 305 and the refracting surface 307 is a curved surface.

As shown in FIG. 3A, the second reflecting surface 305 is a curved surface. Specifically, the illumination light beam 212 projected by the light source 210 is reflected by the first directing surface 303 and travels downward to the second reflecting surface 305. After the reflection of the curved second reflecting surface 305, the illumination light beam 212 would be narrowed and concentrated, so as to enhance the optical strength of the illumination light beam 212 and compensate the attenuation due to the reflection in the optical transfer assembly 30.

As shown in FIG. 3B, it is also practicable that the first directing surface 303 and the second reflecting surface 305 are flat surfaces, and the refracting surface 307 is a curved surface. In this embodiment, the illumination light beam 212 is finally refracted by the curved refracting surface 307, which can narrow and concentrate the illumination light beam 212, so as to enhance the optical strength and compensate the attenuation.

Conceivably, as show in FIG. 3C, it is a preferable embodiment that both of the second reflecting surface 305 and the refracting surface 307 are curved surfaces. As for the abovementioned curved surface, an angle between a normal of maximum curvature of the curved surface and the reflective surface is preferably about 20 degrees.

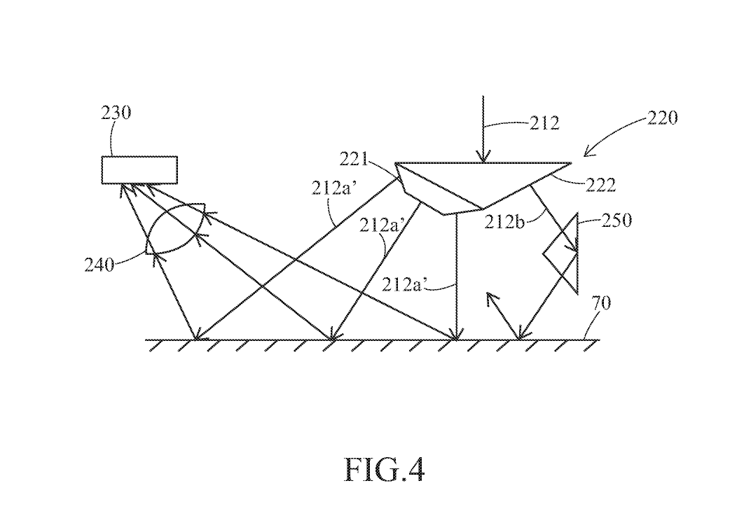

FIG. 4 shows another preferred embodiment. The light beam splitter 220 comprises the first emitting area 221 and the second emitting area 222. The first emitting area 221 is provided for the first light beam 212a travelling through, whereas the second emitting area 222 is provided for the second light beam 212b travelling through. Specifically, the first emitting area 221 has a plurality of emitting surfaces with different normals. The emitting surfaces transfers the first light beam 212a into a plurality of light beams 212a′ with different incident angles on the reflective surface 70.

More specifically, because the emitting surfaces of the first emitting area 221 has different normals, the first light beam 212a is refracted into the plurality of light beams 212a′ having a plurality of different incident angles on the reflective surface 70. Therefore, even if the reflective surface 70 is with different reflection indexes, for example, the reflective surface 70 being with different degrees of roughness, the light beams 212a ′ being received by the image sensor 230 would be sufficient to determine the movement of the optical pointing device 200. Thus, the first emitting area 221 having the emitting surfaces with different normals would improve the sensitivity, especially when the optical pointing device is working on the opaque surface that has different reflection indexes.

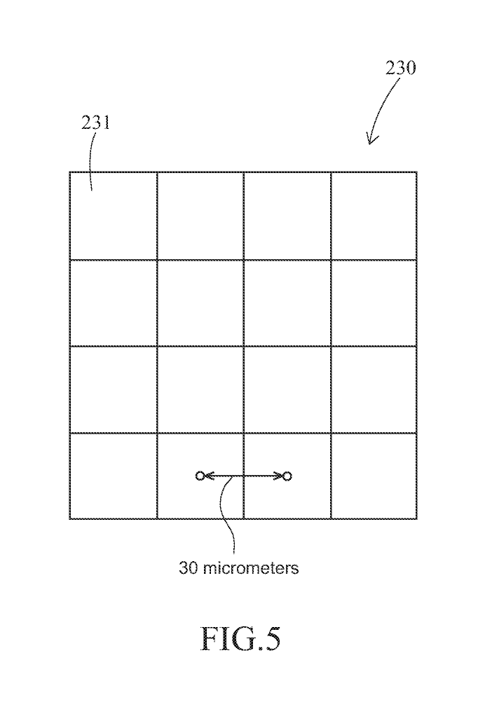

FIG. 5 shows a further embodiment. As mentioned previously, a distance between any two speckles which is formed after the illumination light beam 212 being projecting onto the reflective surface 70 is approximately equal to 7 micrometers. In this embodiment, the image sensor 230 has a plurality of sensor units 231 for sensing speckles formed on the reflective surface 70 and generating image data. As shown in FIG. 5, the sensor units 231 are preferably arranged in the form of a matrix. Each of the sensor units 231 is defined with a geometric center and the sensor units 231 are arranged to have a distance between the geometric centers of two nearest sensor units being shorter than 30 micrometers. The image sensor 230 would be suitable for sensing most of the speckles. Therefore, even if in lack of any additional lens, the image sensor 230 would be sufficient to identify the speckles accurately, and the optical pointing device 200 can accurately determine its movement accordingly.

It is noted that the optical pointing device 200 further comprises a processor coupled to the sensor units 231 for processing the image data and generating a display signal corresponding to the movement of the optical point device 200.

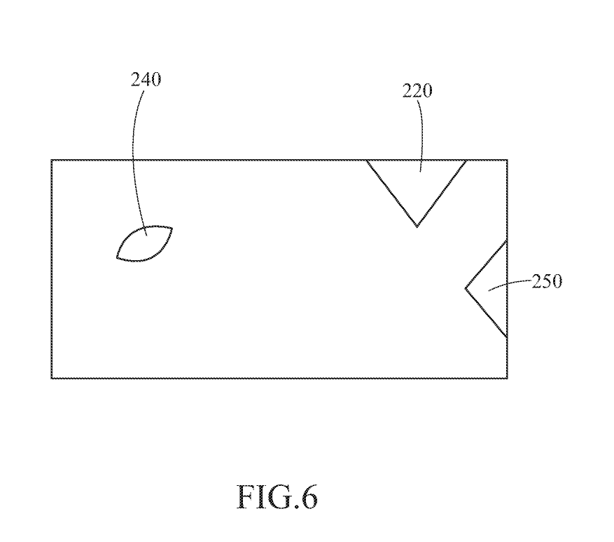

It is indicated that the above-mentioned lens 240, light beam splitter 220 and reflection element 250 can be integrally formed (as illustrated in FIG. 6), which would facilitate the assembly of the optical pointing device 200 and therefore the production efficiency can be improved.

In summary, the optical pointing device in accordance with the present invention can achieve at least the following advantages.

(1) By using the light beam splitter to split the illumination light beam provided by the light source into two light beams, when the optical pointing device is put on the reflective surface or the transparent body which is disposed on the reflective surface, the image sensor can sense different light beams. Therefore, the optical pointing device has good sensitivity regardless of being put on the reflective surface or being put on the transparent body disposed on the reflective surface.

(2) The lens, the light beam splitter and the reflection element of the optical pointing device can be integrally formed to facilitate the manufacturing processes and to improve the manufacturing efficiency of the optical pointing device.

(3) The illumination light beam is capable of being condensed by the optical transfer assembly to enhance the optical strength. It is also beneficial to improve the sensitivity of the optical pointing device.

(4) The illumination light beam could be further scattered with different incident angles. This may be suitable for use on various working surfaces with different roughness.

(5) The sensor units of the image sensor are preferably well arranged as a matrix in the way that the distance between the geometric centers of two nearest sensor units is shorter than 30 micrometers. Thus, the speckles formed by the laser beams reflecting from the reflective surface would be feasible to be determined so as to improve the sensitivity of the optical pointing device.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An optical pointing device, comprising:
a light source providing an illumination light beam;
an optical transfer assembly concentrating the illumination light beam;
a light beam splitter disposed on a transmission path of the illumination light beam after the optical transfer assembly, the light beam splitter splitting the illumination light beam into a first light beam and a second light beam; and
an image sensor being capable of sensing at least one of the first light beam and the second light beam;
wherein the first light beam is reflected by a reflective surface to be guided towards the image sensor when the optical pointing device is directly located on the reflective surface, and the second light beam is reflected by the reflective surface to be guided towards the image sensor when the optical pointing device is located on a transparent body above the reflective surface.

2. The optical pointing device as claimed in claim 1, further comprising a lens disposed before the image sensor for focusing the first light beam or the second light beam onto the image sensor.

3. The optical pointing device as claimed in claim 1, wherein the optical transfer assembly comprises an inlet lens, a first directing surface, a second directing surface and a refracting surface sequentially disposed on the transmission path, wherein the inlet lens focuses the illumination light beam, the first directing surface reflects the illumination light beam from the inlet lens towards the second directing surface, the second directing surface reflecting the illumination light beam from the first directing surface towards the refracting surface, and the refracting surface directs the illumination light beam towards the light beam splitter.

4. The optical pointing device as claimed in claim 3, wherein at least one of the second reflecting surface and the refracting surface is a curved surface, and the inlet lens is a convex lens.

5. The optical pointing device as claimed in claim 4, wherein an angle between a normal of maximum curvature of the curved surface and the reflective surface is about 20 degrees.

6. The optical pointing device as claimed in claim 1, wherein the light beam splitter is a prism or a grating.

7. The optical pointing device as claimed in claim 1, wherein the light beam splitter comprises a first emitting area for the first light beam travelling therethrough and a second emitting area for the second light beam travelling therethrough.

8. The optical pointing device as claimed in claim 7, wherein the first emitting area has a plurality of emitting surfaces with different normals, the emitting surfaces transferring the first light beam into a plurality of light beams with different incident angles on the reflective surface.

9. The optical pointing device as claimed in claim 7, further comprising a reflection element disposed on a transmission path of the second light beam for reflecting the second light beam through the transparent body to the reflective surface.

10. The optical pointing device as claimed in claim 9, wherein the reflection element is a prism or a reflective mirror.

11. The optical pointing device as claimed in claim 1, wherein the image sensor has a plurality of sensor units for sensing speckles formed on the reflective surface and generating image data, wherein each of the sensor units has a geometric center and the sensor units are arranged to have a distance between the geometric centers of two nearest sensor units shorter than 30 micrometers.

12. The optical pointing device as claimed in claim 11, wherein the sensor units are arranged in the form of a matrix.

13. The optical pointing device as claimed in claim 11, further comprising a processor coupled to the sensor units for processing the image data and generating a display signal corresponding to the movement of the optical point device.

14. The optical pointing device as claimed in claim 1, wherein the image sensor is a complementary metal oxide semiconductor image sensor or a charge coupled device.

15. The optical pointing device as claimed in claim 1, wherein the light source is a laser diode.
